(19) United States
(12) Patent Application Publication
(10) Pub. No.: US 2018/0339915 A1
(43) Pub. Date: Nov. 29, 2018

(54) METHOD FOR MANUFACTURING VANADIUM DIOXIDE-CONTAINING PARTICLES

(71) Applicant: Konica Minolta, Inc., Chiyoda-ku, Tokyo (JP)

(72) Inventor: Yasuhiko TAKAMUKI, Hachioji-shi, Tokyo (JP)

(21) Appl. No.: 15/563,058

(22) PCT Filed: Feb. 24, 2016
(86) PCT No.: PCT/JP2016/055493

§ 371 Date: Sep. 29, 2017

(30) Foreign Application Priority Data
Mar. 31, 2015 (JP) 2015-073006

(51) Int. Cl. C01G 31/02

(52) U.S. Cl. CPC C01G 31/02; B82Y 40/00; C01P 2006/60; C01P 2004/64

(57) ABSTRACT

The present invention provides a process for producing particles comprising vanadium dioxide which have excellent thermochromic properties. The process for producing particles comprising vanadium dioxide (VO2) according to the present invention comprises: subjecting a liquid reaction mixture comprising a vanadium-containing compound and water to a hydrothermal reaction; and cooling the resultant reaction product at a cooling rate of 10-300° C./sec immediately after the hydrothermal reaction. The particles have thermochromic properties.

### CROSS REFERENCE TO RELATED APPLICATIONS

This is the U.S. national stage of application No. PCT/JP2016/055493, filed on Feb. 24, 2016. Priority under 35 U.S.C. § 119(a) and 35 U.S.C. § 365(b) is claimed from Japanese Application No. 2015-073006, filed on Mar. 31, 2015, the disclosures of which are also incorporated herein by reference.

### TECHNICAL FIELD

The present invention relates to a method for manufacturing vanadium dioxide (VO₂)-containing particles having an excellent thermochromic property.

### BACKGROUND ART

In a place where large heat exchange occurs (for example, window glass) between an inside (inside of a room or inside of a vehicle) and an external environment in a structure such as a house or a building, or a moving body such as a vehicle, application of a thermochromic material is expected in order to obtain both an energy saving property and comfort.

The “thermochromic material” is a material capable of controlling an optical property such as transparency by temperature. For example, when a thermochromic material is applied to window glass of a structure, heat can be blocked by causing an infrared ray to reflect on the window glass in the summer, and heat can be used by causing an infrared ray to pass through the window glass in the winter.

One of thermochromic materials on which the largest attention is currently focused is a vanadium dioxide (VO₂)-containing material. It is known that vanadium dioxide (VO₂) exhibits a thermochromic characteristic (also referred to as a “thermochromic property” which is a property that an optical characteristic reversibly changes according to temperature) during phase transition around room temperature. Therefore, by utilizing this characteristic, a material exhibiting an environmental temperature-dependent thermochromic characteristic can be obtained.

Herein, in vanadium dioxide (VO₂), polymorphs of several crystal phases such as phase A, phase B, phase C, and a rutile type crystal phase (hereinafter, also referred to as “phase R”) exist. However, a crystal structure exhibiting such a thermochromic characteristic as described above at a relatively low temperature of 100° C. or lower is limited to the phase R. The phase R has a monoclinic structure and has a high transmittance of visible light and an infrared ray at a temperature lower than a phase transition temperature (about 68° C.). Meanwhile, the phase R has a tetragonal structure and has a lower transmittance of an infrared ray than a monoclinic structure at a phase transition temperature or higher.

In a case where such vanadium dioxide (VO₂)-containing particles are applied to window glass or the like, when the vanadium dioxide (VO₂)-containing particles are formed into a film material, transparency (small haze) is required, and desirably, the particles are not aggregated and have nano-order (100 nm or less) particle diameters.

As a method for manufacturing such vanadium dioxide (VO₂)-containing particles, a method for manufacturing phase R vanadium dioxide (VO₂) particles by a hydrothermal reaction has been reported. For example, Patent Literature 1 describes a method for manufacturing vanadium dioxide (VO₂) single crystal fine particles by a hydrothermal reaction of a solution containing hydrazine (N₂H₄) or a hydrate thereof (N₂H₄.nH₂O) and water and substantially not containing titanium dioxide (TiO₂) particles using divanadium pentoxide (V₂O₅) or the like as a raw material.

### CITATION LIST

### Patent Literature

Patent Literature 1: JP 2011-178825 A

### SUMMARY OF INVENTION

### Technical Problem

However, in the manufacturing method described in Patent Literature 1, particle diameters of fine particles of vanadium dioxide (VO₂) obtained by a hydrothermal reaction tend to be large or a particle diameter distribution thereof is wide, and therefore it has been found that transparency is low (haze is high) disadvantageously.

Therefore, the present invention has been achieved in view of the above circumstances, and an object thereof is to provide vanadium dioxide-containing particles having a thermochromic property and excellent transparency (small haze), and a method for manufacturing the same.

### Solution to Problem

The present inventor conducted intensive studies in order to solve the above problem. As a result, it has been found that the above problem is solved and a thermochromic property is also improved by quickly cooling a reaction product immediately after a hydrothermal reaction. Based on the above finding, the present invention has been completed.

That is, the above object can be attained by a method for manufacturing vanadium dioxide (VO₂)-containing particles having a thermochromic characteristic, including performing a hydrothermal reaction of a reaction liquid containing a vanadium-containing compound and water, and cooling a reaction product immediately after the hydrothermal reaction at a cooling rate of 10 to 300° C./sec.

### BRIEF DESCRIPTION OF DRAWINGS

FIG. 1 is a schematic diagram illustrating a preferable form of a flow type reaction apparatus. In FIG. 1, reference sign 1 indicates a micro mixer, reference sign 2 indicates a hydrothermal reaction vessel, reference signs 5, 9, and 10 indicate tanks, reference signs 3, 6, and 11 indicate piping, reference signs 4, 7, and 12 indicate pumps, and reference sign 8 indicates a cooling pipe.

### DESCRIPTION OF EMBODIMENTS

A method for manufacturing vanadium dioxide (VO₂)-containing particles having a thermochromic characteristic according to the present invention includes performing a hydrothermal reaction of a reaction liquid containing a vanadium-containing compound and water and cooling a reaction product immediately after the hydrothermal reaction at a cooling rate of 10 to 300° C./sec. According to the method of the present invention, vanadium dioxide-containing particles having a thermochromic property and excellent transparency (small haze) can be manufactured. Note that here, “vanadium dioxide (VO₂)-containing particles” is also referred to as “vanadium dioxide-containing particles in the present invention” or “VO₂-containing particles in the present invention”, or simply “vanadium dioxide-containing particles” or “VO₂-containing particles”. In addition, a “reaction product immediately after a hydrothermal reaction” is also referred to as a “hydrothermal reaction product according to the present invention” or simply a “hydrothermal reaction product”.

In addition, here, “vanadium dioxide (VO₂)-containing particles having a thermochromic characteristic” means vanadium dioxide (VO₂)-containing particles having a thermochromic property (ΔT(%)) of 20% or more evaluated in the following Examples.

In the above Patent Literature 1, it seems that after a hydrothermal reaction, a reaction product is not cooled particularly artificially, but is cooled as it is, filtered, and washed as usual. For this reason, the hydrothermal reaction product is gradually precipitated, and therefore it is estimated that the number of crystal nuclei is small and crystals grow gradually. For this reason, the resulting vanadium dioxide-containing particles have large particle diameters and a wide particle diameter distribution width. As a result, it is considered that the resulting vanadium dioxide-containing particles have poor transparency (high haze).

In contrast, the present invention is characterized by rapidly cooling a reaction product immediately after a hydrothermal reaction. The vanadium dioxide-containing particles obtained by such an operation have excellent transparency and a better thermochromic property. A mechanism by which the above effect can be achieved is unknown, but is estimated as follows. That is, by rapidly cooling a hydrothermal reaction product, solubility of generated vanadium dioxide-containing particles is rapidly lowered and crystals are precipitated. A large amount of crystal nuclei are generated and crystals grow rapidly. Therefore, the sizes of particles can be reduced, and a particle size distribution of the resulting vanadium dioxide-containing particles can be narrow, thereby improving transparency (small haze). It is considered that a transmittance before exhibition of a thermochromic effect is thereby improved, and this further improves the thermochromic effect.

Note that the above mechanism is estimation, and does not limit the technical scope of the present invention.

Hereinafter, embodiments of the present invention will be described. Note that the present invention is not limited only to the following embodiments.

Here, “X to Y” indicating a range includes X and Y, and means “X or more and Y or less”. In addition, unless otherwise specified, measurement of operation, physical properties, and the like is performed under conditions of room temperature (20 to 25° C.)/relative humidity 40 to 50%.

<Method for Manufacturing Vanadium Dioxide-Containing Particles>

As described above, the method for manufacturing vanadium dioxide (VO₂)-containing particles according to the present invention includes (a) performing a hydrothermal reaction of a reaction liquid containing a vanadium-containing compound and water (hydrothermal reaction step) and (b) cooling the reaction product immediately after the hydrothermal reaction at a cooling rate of 10 to 300° C./sec (cooling step).

(a) Hydrothermal Reaction Step

In this step, a reaction liquid containing a vanadium-containing compound and water is subjected to a hydrothermal reaction. Through this step, a suspension containing a precursor of vanadium dioxide-containing particles is obtained.

The vanadium-containing compound (raw material of vanadium dioxide-containing particles) is not particularly limited, but examples thereof include divanadium (V) pentoxide (V₂O₅), ammonium vanadate (V) (NH₄VO₃), vanadium (V) trichloride oxide (VOCl₃), sodium vanadate (V) (NaVO₃), vanadyl (IV) oxalate (VOC₂O₄), vanadium (IV) oxide sulfate (VOSO₄), divanadium (IV) tetroxide (V₂O₄), and hydrates thereof. Among these compounds, note that the above vanadium-containing compounds may be dissolved or dispersed in a reaction liquid. In addition, the vanadium-containing compounds may be used singly or in a mixture of two or more kinds thereof.

Herein, the hydrothermal reaction method is not particularly limited, and a known method can be applied similarly, or a method obtained by appropriately modifying a known method can be applied. Preferably, the hydrothermal reaction is performed in (a-1) a reaction liquid containing a vanadium (V)-containing compound, water, and a reducing agent (in particular, hydrazine and a hydrate thereof), or in (a-2) a reaction liquid containing a vanadium (IV)-containing compound and water.

In the above (a-1), the vanadium (V)-containing compound (raw material of vanadium dioxide-containing particles) is not particularly limited, and can be appropriately selected from the above compounds. Divanadium pentoxide, ammonium vanadate, and vanadium trichloride oxide are preferable from a viewpoint of preventing generation of by-products as much as possible after the hydrothermal reaction. Divanadium pentoxide and ammonium vanadate are more preferable, and divanadium pentoxide is particularly preferable. Note that the vanadium-containing compounds may be used singly or in a mixture of two or more kinds thereof.

An initial concentration of a vanadium (V)-containing compound contained in a reaction liquid is not particularly limited as long as an objective effect of the present invention is obtained, but is preferably from 0.1 to 500 mmol/L. With such a concentration, a reducing agent functions efficiently, particle diameters of the resulting vanadium dioxide-containing particles are reduced and/or a particle size distribution thereof is narrowed (polydispersity index is lowered), and a thermochromic property can be further increased. The initial concentration of the vanadium (V)-containing compound contained in the reaction liquid is more preferably from 20 to 400 mmol/L, and still more preferably from 50 to 200 mmol/L from a viewpoint of a particle diameter/particle size distribution of vanadium dioxide-containing particles, therefore a thermochromic property or the like. Note that the above “initial concentration” is the amount of the vanadium (V)-containing compound (in a case of containing two or more kinds of vanadium (V)-containing compounds, the total amount thereof) in 1 L of the reaction liquid before the hydrothermal reaction.

In addition, examples of a reducing agent which can be used together with the vanadium (V)-containing compound include oxalic acid and a hydrate thereof, hydrazine and a hydrate thereof, a water-soluble vitamin such as ascorbic acid and a derivative thereof, an antioxidant such as sodium erythorbate, dibutylhydroxytoluene (BHT), butylhydroxyanisole (BHA), propyl gallate, or sodium sulfite, and a reducing sugar such as glucose, fructose, glyceraldehyde, lactose, or maltose. Among these compounds, oxalic acid and a hydrate thereof, and hydrazine and a hydrate thereof are preferable, and hydrazine and a hydrate thereof are more preferable. That is, the hydrothermal reaction is preferably performed in a reaction liquid containing a vanadium (V)-containing compound, water, and at least one of hydrazine (N₂H₄) and a hydrate thereof (N₂H₄.nH₂O). The above reducing agents can be used singly or in combination of two or more kinds thereof. The amount of the reducing agent is not particularly limited, but for example, is preferably from 0.5 to 5.0 moles relative to one mole of a vanadium (V)-containing compound.

In addition, in the above (a-2), the vanadium (IV)-containing compound (raw material of vanadium dioxide-containing particles) is not particularly limited, and can be appropriately selected from the above compounds. Vanadium tetroxide (V₂O₄) is particularly preferable from a viewpoint of preventing generation of by-products as much as possible after the hydrothermal reaction.

An initial concentration of a vanadium (IV)-containing compound contained in a reaction liquid is not particularly limited as long as an objective effect of the present invention is obtained, but is preferably from 0.1 to 500 mmol/L. With such a concentration, a vanadium (IV)-containing compound is sufficiently dissolved, particle diameters of the resulting vanadium dioxide-containing particles are reduced and/or a particle size distribution thereof is narrowed (polydispersity index is lowered), and transparency and a thermochromic property can be further increased. The initial concentration of the vanadium (IV)-containing compound contained in the reaction liquid is more preferably from 20 to 300 mmol/L, and still more preferably from 50 to 200 mmol/L from a viewpoint of a particle diameter/particle size distribution of vanadium dioxide-containing particles, therefore transparency, a thermochromic property, or the like. Note that the above “initial concentration (mmol/L)” is the amount of the vanadium (IV)-containing compound (in a case of containing two or more kinds of vanadium (IV)-containing compounds, the total amount thereof) in 1 L of the reaction liquid before the hydrothermal reaction.

The reaction liquid contains water as a dispersion medium or a solvent of the vanadium-containing compound. The water contained in the reaction liquid is preferably water having little impurities, and is not particularly limited, but distilled water, deionized water, pure water, or ultrapure water can be used, for example. Alternatively, nitrogen (N₂) nanobubble-treated water may be used. Herein, nitrogen (N₂) nanobubble-treated water (N₂ nanobubble-treated water) is prepared by mixing nitrogen (bubbling) in water. By using nitrogen (N₂) nanobubble-treated water, a dissolved oxygen concentration of water is lowered. Therefore, reoxidization of the resulting vanadium dioxide-containing particles is suppressed and prevented, and a yield of vanadium dioxide having a desired crystal phase (rutile type crystal phase) can be further improved. Herein, the dissolved oxygen concentration of nitrogen (N₂) nanobubble-treated water is not particularly limited, but is preferably 2 mg/l or less, and more preferably 1 mg/l or less (lower limit: 0 mg/1).

The reaction liquid may further contain a substance (phase transition control substance) containing an element for controlling a phase transition temperature of vanadium dioxide (VO₂)-containing particles as long as the objective effect of the present invention is achieved. Herein, the substance (phase transition control substance) containing an element for controlling a phase transition temperature of vanadium dioxide (VO₂)-containing particles is not particularly limited. However, a substance containing an element other than vanadium, such as tungsten, titanium, molybdenum, niobium, tantalum, tin, rhenium, iridium, osmium, ruthenium, germanium, chromium, iron, gallium, aluminum, fluorine, or phosphorus can be used. By inclusion of the above phase transition control substance in the reaction liquid, the phase transition temperature of the resulting vanadium dioxide-containing particles can be lowered. Herein, the addition amount of the phase transition control substance is not particularly limited, but is an amount such that the amount of another element contained in the phase transition control substance is preferably from 0.03 to 1 element, and more preferably from 0.04 to 0.08 elements relative to 100 elements of vanadium contained in the vanadium-containing compound. In addition, a form of the phase transition control substance is not particularly limited, but examples of thereof include an oxide and an ammonium salt of the above other element.

In addition, as long as the objective effect of the present invention is achieved, as a pH regulator, the reaction liquid may contain an organic or inorganic acid or alkali, such as hydrochloric acid, sulfuric acid, nitric acid, phosphoric acid, oxalic acid (including a hydrate), ammonium hydroxide, or ammonia. The pH of the reaction liquid immediately after the hydrothermal reaction is, for example, from 3.0 to 9.0, and more preferably from 4.0 to 7.0 from viewpoints of a particle diameter/particle size distribution of vanadium dioxide-containing particles, transparency, and a thermochromic property. Note that when a reducing agent and a pH regulator are used in combination, the pH regulator different from the reducing agent is used. For example, when oxalic acid dihydrate is used as a reducing agent, it is assumed that oxalic acid dihydrate is not a pH regulator.

In addition, the vanadium-containing compound may be pretreated in the presence of hydrogen peroxide before the hydrothermal reaction. By adding hydrogen peroxide, the pH of the reaction liquid can be adjusted, and the vanadium-containing compound can be uniformly dissolved. Alternatively, the vanadium-containing compound may be pretreated in the presence of hydrogen peroxide and a reducing agent before the hydrothermal reaction. For example, before the hydrothermal reaction described below, the reaction liquid prepared as described above is only required to be subjected to a reaction, for example, at 20 to 40° C. for about 0.5 to 10 hours while being stirred as necessary. In a case of adopting a reduction reaction with a reducing agent after the pretreatment with hydrogen peroxide, the above reaction can be performed by sequentially adding hydrogen peroxide and a reducing agent. By performing the pretreatment in the presence of hydrogen peroxide before the hydrothermal reaction, particularly even when a nonionic vanadium-containing compound such as divanadium pentoxide is used, the reaction liquid turns into a sol state, and the hydrothermal reaction can progress uniformly. In addition, as described above, there is an advantage that vanadium dioxide is easily generated by performing the reduction reaction before the hydrothermal reaction.

In this step, the reaction liquid is subjected to the hydrothermal reaction to form a precursor of vanadium dioxide-containing particles. Note that the “hydrothermal reaction” means a synthesis or alteration reaction of minerals performed in the presence of high-temperature water, particularly high-temperature and high-pressure water, specifically a chemical reaction caused in hot water (sub-critical water) the temperature and pressure of which are lower than those at the critical point of water (374° C., 22 MPa). It is known that, unlike in a case of normal pressure and high temperature where little water can exist, a specific reaction can occur due to the presence of water at high pressure. It is also known that the solubility of an oxide such as silica or alumina is improved and a reaction rate is improved. The hydrothermal reaction can be performed using an apparatus such as a reaction decomposition vessel for high pressure, an autoclave, or a test tube type reaction vessel.

Conditions of the hydrothermal reaction are not particularly limited, and can be appropriately set according to other conditions (for example, the amount of a reactant, reaction temperature, reaction pressure, and reaction time). For example, the temperature of the hydrothermal reaction (liquid temperature of reaction liquid) is preferably from 80 to 350° C., and more preferably from 100 to 300° C. In addition, the time of the hydrothermal reaction is preferably from one hour to seven days, and more preferably from five hours to three days. Under the above conditions, a precursor of vanadium dioxide-containing particles having a narrow particle size distribution and a small particle diameter can be efficiently manufactured. Furthermore, a possibility that crystallinity of vanadium dioxide-containing particles is lowered can be avoided. Note that the hydrothermal reaction may be performed in one stage under the same conditions or in multiple stages under various conditions.

The hydrothermal reaction may be performed under stirring. By stirring, a precursor of vanadium dioxide-containing particles can be prepared more uniformly. Furthermore, the hydrothermal reaction may be performed in a batch manner or in a continuous manner.

(b) Cooling Step

In this step, a reaction product (a suspension containing the precursor of vanadium dioxide-containing particles obtained in the above hydrothermal reaction step (a), hydrothermal reaction product) immediately after the hydrothermal reaction is cooled immediately after the hydrothermal reaction at a cooling rate of 10 to 300° C./s. Through this step, vanadium dioxide-containing particles having a narrow particle diameter distribution width and a small diameter can be manufactured efficiently. Herein, the “reaction product immediately after the hydrothermal reaction” means to start cooling the hydrothermal reaction product within one minute after the hydrothermal reaction is performed for a predetermined time (time of completion of the reaction). However, if it is difficult to cool the whole reaction liquid within this time, the reaction liquid is cooled sequentially by a predetermined quantity while the reaction liquid is maintained at a reaction temperature by giving flexibility to the reaction time.

In this step, the hydrothermal reaction product is cooled at a cooling rate of 10 to 300° C./sec. Herein, when the cooling rate is lower than 10° C./s, the particle diameters of the resulting vanadium dioxide-containing particles are large and the particle size distribution thereof is wide (polydispersity index is large) (see Comparative Example 1 described below). Meanwhile, if the cooling rate exceeds 300° C./s, considering that cooling is performed at a reaction temperature of the critical point of water or lower, there is no large difference in cooling time. Considering that the particle diameters of the resulting vanadium dioxide-containing particles are reduced, the particle diameter distribution thereof is narrowed, and the like, the cooling rate is preferably from 20 to 300° C./s, and more preferably from 50 to 300° C./s.

Here, the “cooling rate of the hydrothermal reaction product” is a value obtained by dividing a difference between the temperature of the reaction product immediately after the hydrothermal reaction (hydrothermal reaction product) (temperature of hydrothermal reaction product) and a desired temperature (for example, room temperature (25° C.) to which the reaction product immediately after the hydrothermal reaction has been cooled [(temperature of hydrothermal reaction product)−(desired temperature)] (° C.) by a period of time required for the cooling (a period of time required for lowering the reaction temperature to the predetermined temperature) (sec). In addition, herein, the temperature of the reaction product immediately after the hydrothermal reaction (the temperature of the hydrothermal reaction product) is assumed to be the reaction temperature.

A method for cooling the hydrothermal reaction product is not particularly limited, and a known method can be applied similarly, or a method obtained by appropriately modifying a known method can be applied. Specific examples of the method include a method using a flow type reaction apparatus, a method for immersing the hydrothermal reaction product in a cooling medium, if necessary, under stirring, a method for mixing the hydrothermal reaction product with a cooling medium (particularly water), and a method for causing the hydrothermal reaction product to pass through a gaseous cooling medium (for example, liquid nitrogen). Among these methods, the method using a flow type reaction apparatus and the method for mixing the hydrothermal reaction product with a cooling medium are preferable from a viewpoint of easy control of the cooling rate. Herein, at least cooling is preferably performed using a flow type reaction apparatus.

Hereinafter, a preferable embodiment of cooling the hydrothermal reaction product using a flow type reaction apparatus will be described. Note that the present invention is not limited to the following embodiment.

According to the present embodiment, the hydrothermal reaction product is cooled by causing the hydrothermal reaction product to passes (flows) through a flow path of a flow type reaction apparatus. Herein, the flow type reaction apparatus is not particularly limited, and a known apparatus can be used. However, a micro mixer can be particularly preferably used from viewpoints of being able to perform rapid cooling as in the present invention and easy control of a cooling rate. Herein, the “micro mixer” means a mixer that realizes high-speed mixing by utilizing a space of a minute flow path (micro flow path). By using the micro mixer, a contact area between the hydrothermal reaction product and an outside world (for example, air or a cooling medium) can be increased, and therefore the hydrothermal reaction product can be cooled rapidly.

The micro mixer is not particularly limited, and a known apparatus can be used except that a hydrothermal reaction vessel is connected. Specifically, apparatuses described in WO 2012/43557, JP 2013-132616 A, JP 2012-254581 A, JP 2012-254580 A, JP 2009-208052 A, JP 2008-12453 A, JP 2005-255450 A, and the like can be appropriately modified, if necessary, to be used. Alternatively, commercially available products such as Micro Mixer manufactured by ITEC Co., Ltd. and ULREA manufactured by M Technique Co., Ltd. may be used.

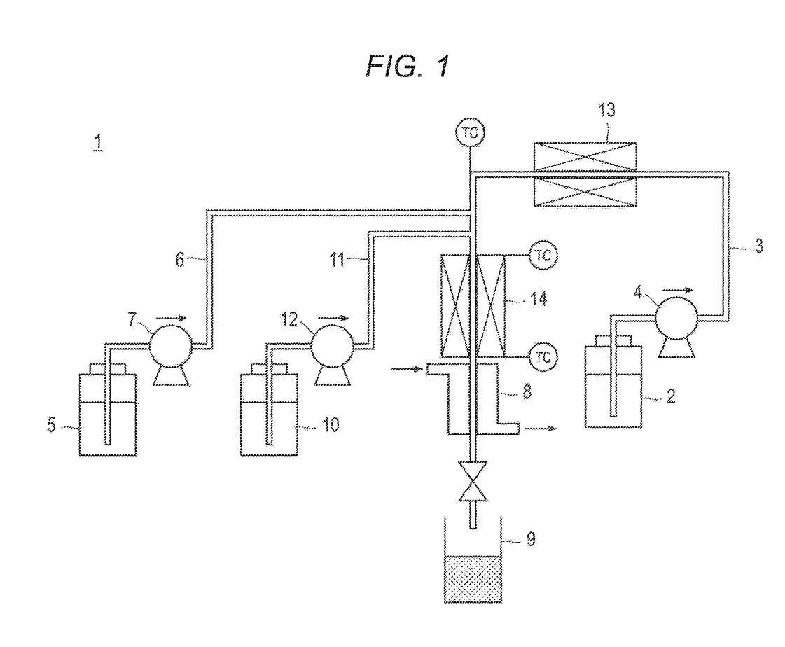

A specific structure of a micro mixer is illustrated in FIG. 1. FIG. 1 is a schematic diagram illustrating a micro mixer which is a preferable form of a flow type reaction apparatus. In FIG. 1, a micro mixer 1 includes a hydrothermal reaction vessel (tank) 2 for containing a hydrothermal reaction product, a tank 9 for containing the hydrothermal reaction product after cooling, a micro flow path (piping) 3 for connecting the tank 2 to the tank 9, and a pump 4 for causing the hydrothermal reaction product to flow from the tank 2 to the tank 9. Furthermore, the micro mixer 1 may include a cooling pipe 8 for further cooling the hydrothermal reaction product, if necessary. In addition, as described in detail below, for the purpose of mixing the hydrothermal reaction product with a cooling medium (for example, water) and cooling the mixture, the micro mixer 1 may further include a tank 5 for containing the cooling medium, and a pump 7 for causing the cooling medium to flow through piping 6. Similarly, as described in detail below, for the purpose of further adding a function to the hydrothermal reaction product, the micro mixer 1 may further include a tank 10 for containing a functional addition medium (for example, a surface modifier) for adding the function, and a pump 12 for causing the functional addition medium to flow through piping 11. Furthermore, the micro mixer 1 may further include heating media 13 and 14, if necessary.

Herein, the cooling rate may be controlled by any method, but can be controlled, for example, by a material, a length, an inner diameter, a wall thickness, and the like of a micro flow path of a micro mixer. A material of a micro flow path of a micro mixer is not particularly limited, but examples thereof include stainless steel, aluminum, iron, and Hastelloy. Note that an inner surface of a flow path may be glass-coated in order to suppress elution from the flow path. The length of a micro flow path is not particularly limited, but is preferably from 50 to 10,000 mm, and more preferably from 100 to 1,000 mm. A gap (inner diameter in a case of piping) of a micro flow path is not particularly limited, but is preferably from 0.001 to 10 mm, and more preferably from 0.005 to 2 mm. With a micro flow path having such a material and shape, the hydrothermal reaction product can be effectively cooled at a predetermined rate. Note that the piping 3, 6, and 11 preferably has the above materials, lengths, and inner diameters, but the materials, lengths, and inner diameters thereof may be the same as or different from one another.

In addition, a rate (flow rate) at which the hydrothermal reaction product passes (flows) through a micro flow path is not particularly limited. The flow rate is preferably 0.01 ml/sec or more, more preferably 0.1 ml/sec or more, and still more preferably 0.5 ml/sec or more. In addition, the flow rate is preferably 500 ml/sec or less, more preferably 50 ml/sec or less, still more preferably 10 ml/sec or less, and particularly preferably 5 ml/sec or less. That is, the flow rate is preferably from 0.01 to 500 ml/sec, more preferably from 0.01 to 50 ml/sec, still more preferably from 0.01 to 10 ml/sec, and particularly preferably from 0.1 to 5 ml/sec. With such a flow rate, the hydrothermal reaction product can be effectively cooled at a predetermined rate.

As described above, the cooling medium may be mixed with the hydrothermal reaction product by causing the cooling medium to flow from the tank 5 through the piping 6 with the pump 7. By this operation, the cooling rate of the hydrothermal reaction product can be further increased. Herein, the cooling medium is not particularly limited, but is preferably the same as a liquid contained in the hydrothermal reaction product, that is, water. Therefore, according to the preferable embodiment of the present invention, cooling is performed by mixing the reaction product immediately after the hydrothermal reaction and water. At this time, the water is not particularly limited, and is similar to that defined in the above step (a), and therefore description thereof is omitted herein. The cooling medium is preferably deionized water or nitrogen (N₂) nanobubble-treated water. In addition, at least one of water used for the hydrothermal reaction and water used for cooling is nitrogen (N₂) nanobubble-treated water. In the cooling medium, at least the water used for cooling is more preferably nitrogen (N₂) nanobubble-treated water. This can further suppress and prevent reoxidization of the resulting vanadium dioxide-containing particles, and can further improve a yield of vanadium dioxide having a desired crystal phase (rutile type crystal phase).

A mixing ratio between the cooling medium and the hydrothermal reaction product in a case of using the cooling medium is not particularly limited as long as a desired cooling rate can be achieved. For example, the cooling medium is preferably mixed at a ratio of 1 to 2000 times (volume ratio), more preferably 10 to 1000 times (volume ratio) relative to the hydrothermal reaction product. Note that the above mixing ratio can be controlled by setting the flow rate of the hydrothermal reaction product and the cooling medium to the above ratios. The temperature of the cooling medium is not particularly limited, but is preferably higher than the phase transition temperature (about 68° C.) of vanadium dioxide, and more preferably from 70 to 95° C. Alternatively or additionally, the temperature of the mixture of the reaction product immediately after the hydrothermal reaction and water is more preferably maintained at 70° C. to 95° C. for five minutes or more after the hydrothermal reaction product is mixed with water. That is, according to the preferable embodiment of the present invention, the temperature of water used for cooling is from 70° C. to 95° C., and the temperature of the mixture of the reaction product immediately after the hydrothermal reaction and water is maintained at 70° C. to 95° C. for five minutes or more after the reaction product immediately after the hydrothermal reaction is mixed with water. By setting the temperature to such a temperature, vanadium dioxide is precipitated in the rutile type crystal phase (phase R) state (tetragonal structure). Therefore, the purity of desired vanadium dioxide in the rutile type crystal phase (phase R) can be further improved. Note that the upper limit of the time for maintaining the temperature of the mixture of the reaction product immediately after the hydrothermal reaction and water is not particularly limited, but 10 minutes or less after the reaction product immediately after the hydrothermal reaction is mixed with water is sufficient.

When a cooling medium is used, the pH of the mixture of the hydrothermal reaction product and a cooling medium (preferably water) is not particularly limited, but is preferably from 4 to 8, and more preferably from 4 to 7. That is, according to the preferable embodiment of the present invention, the pH of the mixture of the reaction product immediately after the hydrothermal reaction and water is from 4 to 7. By setting the pH to the above values, the stability of vanadium dioxide particles after particle formation (crystal precipitation) can be improved. Therefore, the purity of desired vanadium dioxide in the rutile type crystal phase (phase R) can be further improved, and the thermochromic property of vanadium dioxide particles can be more effectively improved.

In an embodiment using a cooling medium, a position (position where the piping 6 is disposed) of mixing the hydrothermal reaction product and the cooling medium is not particularly limited. However, considering a cooling efficiency of the hydrothermal reaction product and the like, the piping 6 is preferably connected to the piping 3 at a position of 10 to 500 mm away from an outlet of the piping 3 on a side of the tank 9.

Alternatively or additionally, a surface modifier may be mixed with the hydrothermal reaction product by causing the surface modifier to flow from the tank 10 through the piping 11 with the pump 12. That is, according to the preferable embodiment of the present invention, the reaction product immediately after the hydrothermal reaction is mixed with water, and then a surface modifier is further mixed therewith. By using the surface modifier, aggregation of vanadium dioxide particles is effectively suppressed and prevented, the sizes (particle diameters) of the vanadium dioxide particles are further reduced, the particle size distribution is narrowed, and the dispersion stability and storage stability of the vanadium dioxide particles can be further improved. Therefore, the haze of the vanadium dioxide particles can be more effectively reduced, and the thermochromic property can be more effectively improved.

Herein, examples of the surface modifier include an organic silicon compound, an organic titanium compound, an organic aluminum compound, an organic zirconia compound, a surfactant, and a silicone oil. The number of reactive groups of the surface modifier is not particularly limited, but is preferably 1 or 2.

Specific examples of the organic silicon compound (organosilicate compound) used as a surface modifier include hexamethyldisilazane, trimethylethoxysilane, trimethylmethoxysilane, tetraethoxysilane (tetraethyl orthosilicate), trimethylsilyl chloride, methyl triethoxysilane, dimethyldiethoxysilane, decyltrimethoxysilane, vinyltrichlorosilane, vinyltrimethoxysilane, vinyltriethoxysilane, N-(2-aminoethyl)-3-aminopropyltriethoxysilane, 3-aminopropyltriethoxysilane, 3-phenylaminopropyltrimethoxysilane, 3-mercaptopropylmethyldimethoxysilane, 2-(3,4-epoxycyclohexyl) ethyltrimethoxysilane, and 3-glycidoxypropylmethyldimethoxysilane. In addition, as a commercially available product, for example, SZ 6187 (manufactured by Dow Corning Toray Co., Ltd.) can be suitably used. Among these compounds, it is preferable to use an organosilicate compound having a small molecular weight and high durability, and it is more preferable to use hexamethyldisilazane, tetraethoxysilane, trimethylethoxysilane, trimethylmethoxysilane, or trimethylsilyl chloride.

Examples of the organic titanium compound include tetrabutyl titanate, tetraoctyl titanate, tetraisopropyl titanate, tetra normal butyl titanate, butyl titanate dimer, isopropyl triisostearoyl titanate, isopropyl tridecylbenzene sulfonyl titanate, and bis(dioctyl pyrophosphate) oxyacetate titanate, and as a chelate compound, titanium acetylacetonate, titanium tetraacetylacetonate, titanium ethylacetoacetate, a titanium phosphate compound, titanium octylene glycolate, titanium ethylacetoacetate, a titanium lactate ammonium salt, titanium lactate, and titanium triethanol aminate. Examples of a commercially available product include Plenact TTS (manufactured by Ajinomoto Fine-Techno Co., Ltd.) and Plenact TTS 44 (manufactured by Ajinomoto Fine-Techno Co., Ltd.).

Examples of the organic aluminum compound include aluminum isopropoxide and aluminum tert-butoxide.

Examples of the organic zirconia compound include normal propyl zirconate, normal butyl zirconate, zirconium tetraacetyl acetonate, zirconium monoacetyl acetonate, and zirconium tetraacetylacetonate.

The surfactant is a compound having a hydrophilic group and a hydrophobic group in the same molecule. Specific examples of the hydrophilic group of the surfactant include a hydroxy group, a hydroxyalkyl group having 1 or more carbon atoms, a hydroxyl group, a carbonyl group, an ester group, an amino group, an amide group, an ammonium salt, a thiol, a sulfonate, a phosphate, and a polyalkylene glycol group. Herein, the amino group may be any of primary, secondary, and tertiary amino groups. Specific examples of the hydrophobic group of the surfactant include an alkyl group, a silyl group having an alkyl group, and a fluoroalkyl group. Herein, the alkyl group may have an aromatic ring as a substituent. The surfactant only needs to have at least one hydrophilic group and at least one hydrophobic group as described above in the same molecule, and may have two or more hydrophilic groups or hydrophobic groups. More specific examples of such a surfactant include myristyl diethanolamine, 2-hydroxyethyl-2-hydroxydodecylamine, 2-hydroxyethyl-2-hydroxytridecylamine, 2-hydroxyethyl-2-hydroxytetradecylamine, pentaerythritol monostearate, pentaerythritol distearate, pentaerythritol tristearate, di-2-hydroxyethyl-2-hydroxydodecylamine, alkyl (having 8 to 18 carbon atoms) benzyl dimethyl ammonium chloride, ethylene bisalkyl (having 8 to 18 carbon atoms) amide, stearyl diethanol amide, lauryl diethanol amide, myristyl diethanol amide, palmityl diethanol amide, perfluoroalkenyl, and a perfluoroalkyl compound.

Examples of the silicone oil include a straight silicone oil such as dimethyl silicone oil, methyl phenyl silicone oil, or methyl hydrogen silicone oil, and a modified silicone oil such as amino-modified silicone oil, epoxy-modified silicone oil, carboxyl-modified silicone oil, carbinol-modified silicone oil, methacrylic modified silicone oil, mercapto-modified silicone oil, heterogeneous functional group-modified silicone oil, polyether-modified silicone oil, methyl styryl-modified silicone oil, hydrophilic specially modified silicone oil, higher alkoxy-modified silicone oil, higher fatty acid-containing modified silicone oil, or fluorine-modified silicone oil.

The surface modifier is appropriately diluted, for example, with hexane, toluene, methanol, ethanol, acetone, or water, and is mixed with the hydrothermal reaction product in a form of a solution. In addition, the number of carbon atoms in an organic functional group introduced by the surface modifier is preferably from 1 to 6. This can improve durability. In addition, the pH of the solution containing the surface modifier may be adjusted to an appropriate pH value (for example, 2 to 12) using a pH regulator. Here, the pH regulator is not particularly limited, and those similar to the pH regulator used in the above reaction liquid can be used.

The addition amount of the surface modifier in a case of using the surface modifier is not particularly limited, but is preferably in a range of 1 to 200% by mass, and more preferably in a range of 10 to 100% by mass relative to a vanadium compound. With the above amount, surfaces of the particles are sufficiently surface-modified, and an effect of the surface modifier (effect of suppressing particle aggregation, dispersion stability, and preservation stability) can be exhibited sufficiently effectively while durability is secured because of a small ratio of an organic portion.

In addition, in the present embodiment, a rate (flow rate) at which a solution containing the surface modifier passes (flows) through piping (micro flow path) is not particularly limited, but is preferably from 0.01 to 10 ml/sec, and more preferably from 0.1 to 5 ml/sec. With such a flow rate, the surface modifier and the precursor of vanadium dioxide-containing particles are sufficiently brought into contact with each other, and an effect of the surface modifier (effect of suppressing particle aggregation, dispersion stability, and preservation stability) can be exhibited sufficiently effectively while durability is secured because of a small ratio of an organic portion.

In the present embodiment, a position (position where the piping 11 is disposed) of mixing the hydrothermal reaction product and the surface modifier is not particularly limited. However, in a case of cooling with a cooling medium, the piping 11 is preferably disposed so as to mix the hydrothermal reaction product and the surface modifier after the cooling medium is mixed.

The hydrothermal reaction product is cooled as described above. The cooled hydrothermal reaction product is subjected to replacement of a dispersion medium or a solvent by filtration (for example, ultrafiltration) or centrifugation, and the vanadium dioxide-containing particles may be washed with water, an alcohol (for example, ethanol), or the like. The resulting vanadium dioxide-containing particles may be dried by any means.

By the above method, vanadium dioxide-containing particles having excellent transparency and thermochromic property are provided. That is, the present invention encompasses vanadium dioxide (VO₂)-containing particles manufactured by the manufacturing method of the present invention.

The vanadium dioxide particles manufactured by the method of the invention have small particle diameters and a narrow particle size distribution. Herein, the average particle diameter (diameter) (D (nm)) of the vanadium dioxide particles is not particularly limited, but is 100 nm or less, preferably 60 nm or less, and more preferably 35 nm or less. Note that the lower limit of the average particle diameter (D (nm)) of the vanadium dioxide particles is not particularly limited, but is preferably 5 nm or more. The vanadium dioxide particles having such particle diameters can satisfactorily lower a haze, and can effectively improve a thermochromic property. Note that the particle diameters of the vanadium dioxide particles can be measured by electron microscope observation or a particle diameter measurement method based on a dynamic light scattering method. In a case of measuring a particle diameter based on a dynamic light scattering method, a fluid mechanical diameter is measured using a dynamic light scattering analyzer (DLS-8000, manufactured by Otsuka Electronics Co., Ltd.) by the dynamic light scattering (DLS) method. Here, as an average particle diameter (D (nm)) of the vanadium dioxide particles, a value measured by a method described in the following Examples is adopted.

In addition, the particle size distribution of the vanadium dioxide particles is not particularly limited. However, when a polydispersity index (PDI) is used as an index, the polydispersity index (PDI) is 0.20 or less, preferably from 0.01 to 0.15, and more preferably from 0.01 to 0.10. The vanadium dioxide particles having such a particle size distribution can effectively improve transparency and a thermochromic property. Note that here, as the “polydispersity index (PDI)” indicating a particle size distribution of vanadium dioxide particles, a value measured by a method described in the following Examples is adopted.

In addition, another embodiment of the present invention is a dispersion liquid containing vanadium dioxide-containing particles obtained by the method of the present invention. The vanadium dioxide particles according to the present invention have small particle diameters and a narrow particle size distribution (uniform particle diameter). Therefore, by applying a dispersion liquid containing such particles, a thermochromic characteristic can be improved, and an influence of a haze can be reduced. Therefore, a film having high transparency can be provided.

As the dispersion liquid, a cooling liquid (reaction liquid) after a cooling step can be used as it is. Alternatively, the cooling liquid (reaction liquid) may be diluted by adding water, an alcohol, or the like thereto, or the cooling liquid (reaction liquid) may be replaced with water, an alcohol, or the like.

A dispersion medium of the dispersion liquid may contain only water, but may contain, for example, an organic solvent of about 0.1 to 10% by mass (in the dispersion liquid) such as an alcohol including methanol, ethanol, isopropanol, and butanol, or a ketone including acetone, in addition to water. In addition, as the dispersion medium, a phosphate buffer solution, a phthalate buffer solution, or the like can also be used.

The pH of the dispersion liquid may be adjusted to a desired pH using an organic or inorganic acid or alkali such as hydrochloric acid, sulfuric acid, nitric acid, phosphoric acid, phthalic acid, ammonium hydroxide, or ammonia.

The pH of the dispersion liquid is preferably from 4 to 7 from a viewpoint of suppressing aggregation of vanadium dioxide-containing particles in the dispersion liquid.

The vanadium dioxide-containing particles according to the present invention and vanadium dioxide-containing particles obtained by the manufacturing method according to the present invention can be used as a heat shielding film by mixing the vanadium dioxide-containing particles with a resin such as polyvinyl alcohol, or can be used as a thermochromic pigment, for example.

Still another embodiment of the present invention is an optical film including a transparent substrate and an optical functional layer formed on the transparent substrate and containing a resin and vanadium dioxide (VO₂)-containing particles obtained by the method of the present invention.

Herein, the transparent substrate applicable to the optical film is not particularly limited as long as being transparent, and examples thereof include glass, quartz, and a transparent resin film. However, a transparent substrate is preferable from viewpoints of adding flexibility and production suitability (manufacturing step suitability). The term “transparent” as used in the present invention means that the average light transmittance in a visible light region is 50% or more, preferably 60% or more, more preferably 70% or more, and particularly preferably 80% or more.

The thickness of the transparent substrate according to the present invention is preferably in a range of 30 to 200 μm, more preferably in a range of 30 to 100 μm, and still more preferably in a range of 35 to 70 μm. If the thickness of the transparent resin film is 30 μm or more, wrinkles and the like are less likely to be generated during handling. If the thickness is 200 μm or less, when laminated glass is manufactured, followability to a glass curved surface is improved when the transparent resin film is pasted on a glass substrate.

The transparent substrate according to the present invention is preferably a biaxially oriented polyester film, but an unstretched polyester film or a polyester film which has been stretched in at least one direction can be also used. A stretched film is preferable from viewpoints of improvement in strength and suppression of thermal expansion. In particular, in a case where laminated glass containing the optical film according to the present invention is used as a windshield of an automobile, a stretched film is more preferable.

The transparent substrate according to the present invention has a thermal shrinkage ratio preferably in a range of 0.1 to 3.0%, more preferably in a range of 1.5 to 3.0%, still more preferably in a range of 1.9 to 2.7% at a temperature of 150° C. from a viewpoint of preventing generation of wrinkles in the optical film and cracking of an infrared reflecting layer.

As described above, the transparent substrate applicable to the optical film according to the present invention is not particularly limited as long as being transparent. However, various resin films are preferably used. Examples thereof include a polyolefin film (for example, polyethylene or polypropylene), a polyester film (for example, polyethylene terephthalate or polyethylene naphthalate), polyvinyl chloride film, and a triacetyl cellulose film. The polyester film and the triacetyl cellulose film are preferable.

The polyester film (hereinafter, simply referred to as “polyester”) is not particularly limited, but is preferably a polyester containing a dicarboxylic acid component and a diol component as main constituent components and having a film-forming property. Examples of the dicarboxylic acid component as a main constituent component include terephthalic acid, isophthalic acid, phthalic acid, 2,6-naphthalene dicarboxylic acid, 2,7-naphthalene dicarboxylic acid, diphenyl sulfone dicarboxylic acid, diphenyl ether dicarboxylic acid, diphenylethane dicarboxylic acid, cyclohexane dicarboxylic acid, diphenyl dicarboxylic acid, diphenyl thioether dicarboxylic acid, diphenyl ketone dicarboxylic acid, and phenyl indane dicarboxylic acid. Examples of the diol component include ethylene glycol, propylene glycol, tetramethylene glycol, cyclohexane dimethanol, 2,2-bis(4-hydroxyphenyl) propane, 2,2-bis(4-hydroxyethoxyphenyl) propane, bis(4-hydroxyphenyl) sulfone, bisphenol fluorene dihydroxyethyl ether, diethylene glycol, neopentyl glycol, hydroquinone, and cyclohexane diol. Among polyesters containing these compounds as main constituent components, a polyester containing terephthalic acid or 2,6-naphthalene dicarboxylic acid as a dicarboxylic acid component serving as a main constituent component, and containing ethylene glycol or 1,4-cyclohexanedimethanol as a diol component serving as a main constituent component is preferable from viewpoints of transparency, mechanical strength, dimensional stability, and the like. Among the polyesters, a polyester containing polyethylene terephthalate or polyethylene naphthalate as a main constituent component, a copolymerized polyester formed of terephthalic acid, 2,6-naphthalene dicarboxylic acid, and ethylene glycol, and a polyester containing a mixture of two or more of these polyesters as a main constituent component are preferable.

In a case where a transparent resin film is used as the transparent substrate according to the present invention, the transparent resin film may contain particles in a range not to impair transparency in order to facilitate handling. Examples of particles which can be adopted for the transparent resin film include inorganic particles such as calcium carbonate, calcium phosphate, silica, kaolin, talc, titanium dioxide, alumina, barium sulfate, calcium fluoride, lithium fluoride, zeolite, or molybdenum sulfide, and organic particles such as crosslinked polymer particles or calcium oxalate. In addition, examples of a method for adding particles include a method for adding particles while the particles are contained in a polyester as a raw material and a method for directly adding particles to an extruder. Either one of these methods may be adopted, or the two methods may be used together. In the present invention, an additive may be added in addition to the above particles, if necessary. Examples of such an additive include a stabilizer, a lubricant, a crosslinking agent, an antiblocking agent, an antioxidant, a dye, a pigment, and an ultraviolet absorber.

The transparent resin film which is a transparent substrate can be manufactured by a conventionally known general method. For example, an unstretched transparent resin film which is substantially amorphous and unoriented can be manufactured by melting a resin as a material with an extruder, extruding the resin with a circular die or a T die, and rapidly cooling the resin. In addition, a stretched transparent resin film can be manufactured by stretching an unstretched transparent resin film in a direction of flowing of the transparent resin film (longitudinal axis) or a direction perpendicular to the flowing direction of the transparent resin film (transverse axis) by a known method such as uniaxial stretching, tenter type sequential biaxial stretching, tenter type simultaneous biaxial stretching, or tubular type simultaneous biaxial stretching. In this case, the stretching magnification can be appropriately selected according to a resin as a raw material of the transparent resin film, but is preferably from 2 to 10 times in each of the longitudinal axis direction and the transverse axis direction.

In addition, the transparent resin film may be subjected to a relaxation treatment and an offline heat treatment from a viewpoint of dimensional stability. The relaxation treatment is preferably performed in a step after heat setting is performed in a step of stretching and forming the polyester film and before the polyester film is wound in a tenter for lateral stretching or after the polyester film leaves the tenter. The relaxation treatment is performed preferably at a treatment temperature of 80 to 200° C., and more preferably at a treatment temperature of 100 to 180° C. In addition, in both the longitudinal direction and the transverse direction, the relaxation treatment is performed at a relaxation ratio of preferably in a range of 0.1 to 10%, more preferably in a range of 2 to 6%. The relaxed substrate is subjected to an off-line heat treatment, and thereby has better heat resistance and better dimensional stability.

An undercoat layer coating liquid is preferably applied onto one surface or both surfaces of the transparent resin film in-line in a film forming step. In the present invention, undercoating in the film forming step is referred to as in-line undercoating. Examples of a resin used in the undercoat layer coating liquid useful in the present invention include a polyester resin, an acrylic modified polyester resin, a polyurethane resin, an acrylic resin, a vinyl resin, a vinylidene chloride resin, a polyethyleneimine vinylidene resin, a polyethyleneimine resin, a polyvinyl alcohol resin, a modified polyvinyl alcohol resin, and gelatin, and any of these resins can be preferably used. A conventionally known additive can be added to these undercoat layers. Then, the above undercoat layer can be coated by a known method such as roll coating, gravure coating, knife coating, dip coating, spray coating, or the like. The application amount of the above undercoat layer is preferably about from 0.01 to 2 g/m² (dry state).

An optical functional layer containing a resin and the vanadium dioxide (VO₂)-containing particles according to the present invention is disposed on the above transparent substrate.

Herein, the resin is not particularly limited, and a resin similar to those used in a conventional optical functional layer can be used. A water-soluble polymer can be preferably used. Herein, the water-soluble polymer means a polymer dissolved in an amount of 0.001 g or more in 100 g of water at 25° C. Specific examples of the water-soluble polymer include polyvinyl alcohol, polyethylene imine, gelatin (for example, a hydrophilic polymer typified by gelatin described in JP 2006-343391 A), starch, guar gum, alginate, methyl cellulose, ethyl cellulose, hydroxyalkylcellulose, carboxyalkylcellulose, polyacrylamide, polyethyleneimine, polyethylene glycol, polyalkylene oxide, polyvinylpyrrolidone (PVP), polyvinylmethylether, carboxyvinyl polymer, polyacrylic acid, sodium polyacrylate, naphthalene sulfonic acid condensate, a protein such as albumin or casein, and a sugar derivative such as sodium alginate, dextrin, dextran, or dextran sulfate.

Various additives applicable to the optical functional layer in a range not impairing an objective effect of the present invention are listed below. Examples thereof include various known additives such as UV absorbers described in JP 57-74193 A, JP 57-87988 A, and JP 62-261476 A, anti-fading agents and various anionic, cationic, and nonionic surfactants described in JP 57-74192 A, JP 57-87989 A, JP 60-72785 A, JP 61-146591 A, JP 1-95091 A, and JP 3-13376 A, fluorescent whitening agents described in JP 59-42993 A, JP 59-52689 A, JP 62-280069 A, JP 61-242871 A, and JP 4-219266 A, a pH regulator such as sulfuric acid, phosphoric acid, acetic acid, citric acid, sodium hydroxide, potassium hydroxide, or potassium carbonate, an antifoaming agent, a lubricant such as diethylene glycol, a preservative, an antifungal agent, an antistatic agent, a matting agent, a heat stabilizer, an antioxidant, a flame retardant, a nucleating agent, inorganic particles, organic particles, a viscosity reducer, a lubricant, an infrared absorber, a dye, and a pigment.

A method for manufacturing the optical film (method for forming the optical functional layer) is not particularly limited, and a known method can be applied similarly, or a method obtained by appropriately modifying a known method can be applied except that the vanadium dioxide (VO₂)-containing particles according to the present invention are used. Specifically, a method for preparing a coating liquid containing vanadium dioxide (VO2)-containing particles, applying the coating liquid onto a transparent substrate by a wet coating method, and drying the coating liquid to form an optical functional layer is preferable.

In the above method, the wet coating method is not particularly limited, and examples thereof include a roll coating method, a rod bar coating method, an air knife coating method, a spray coating method, a slide type curtain coating method, and a slide hopper coating method and an extrusion coating method described in U.S. Pat. No. 2,761,419, U.S. Pat. No. 2,761,791, and the like.

The optical film in the present invention may further include another layer in addition to the above constituent members. Herein, examples of the other layer include a near infrared shielding layer, an ultraviolet absorbing layer, a gas barrier layer, a corrosion preventing layer, an anchor layer (primer layer), an adhesive layer, and a hard coat layer, although not being limited thereto.

### EXAMPLES

An effect of the present invention will be described using the following Examples and Comparative Example. However, the technical scope of the present invention is not limited only to the following Examples. Note that, in the following Examples, operations were performed at room temperature (25° C.) unless otherwise specified. Note that “%” and “parts” mean “% by mass” and “parts by mass”, respectively, unless otherwise specified.

### Example 1

Divanadium (V) pentoxide (V₂O₅, special grade, manufactured by Wako Pure Chemical Industries, Ltd.), oxalic acid dihydrate ((COOH)₂.2H₂O, special grade, manufactured by Wako Pure Chemical Industries, Ltd.), and 200 ml of pure water were mixed at room temperature so as to have a molar ratio of 1:2:300, and were sufficiently stirred to prepare a reaction liquid.

Subsequently, 20 ml of this reaction liquid was put in the hydrothermal reaction vessel 2 of the flow type reaction apparatus illustrated in FIG. 1, was heated at 100° C. for eight hours, and then was subjected to a hydrothermal reaction treatment at 270° C. for 24 hours.

A hydrothermal reaction product (liquid temperature=270° C.) was fed to the tank 9 at a rate of 0.5 ml/sec through the micro flow path 3 within one minute after a reaction occurred for a predetermined time. Herein, when the temperature of a dispersion liquid in the tank 9 was continuously measured, time (liquid feeding time) until the temperature of the dispersion liquid in the tank 9 reached room temperature (25° C.) was 24.5 seconds. Therefore, a cooling rate was 10° C./s. In addition, the pH of the dispersion liquid in the tank 9 was measured and was found to be about 4.3.

The resulting dispersion liquid was filtered to separate a product, and then the product was washed with water and ethanol. Furthermore, this product was dried at 60° C. for 10 hours using a constant temperature drier to obtain vanadium dioxide-containing particles 1.

### Example 2

The hydrothermal reaction treatment was performed in a similar manner to Example 1.

A hydrothermal reaction product (liquid temperature=270° C.) was fed to the tank 9 at a rate of 0.5 ml/sec through the micro flow path 3 within one minute after a reaction occurred for a predetermined time. Note that in FIG. 1, in the cooling pipe 8, cooling water was fed such that the cooling pipe 8 maintained a temperature of 5° C. Herein, when the temperature of the dispersion liquid in the tank 9 was continuously measured, the time (liquid feeding time) until the temperature of the dispersion liquid in the tank 9 reached room temperature (25° C.) was about 12.2 seconds. Therefore, a cooling rate was 20° C./s. In addition, the pH of the dispersion liquid in the tank 9 was measured and was found to be about 4.3.

The resulting dispersion liquid was filtered to separate a product, and then the product was washed with water and ethanol. Furthermore, this product was dried at 60° C. for 10 hours using a constant temperature drier to obtain vanadium dioxide-containing particles 2.

### Example 3

To an aqueous solution obtained by mixing 2 ml of 35% by mass hydrogen peroxide water (manufactured by Wako Pure Chemical Industries, Ltd.) and 20 ml of pure water, 0.5 g of divanadium (V) pentoxide (V₂O₅, special grade, manufactured by Wako Pure Chemical Industries, Ltd.) was added, and the mixture was stirred at 30° C. for four hours. Thereafter, a 5% by mass aqueous solution of hydrazine monohydrate (N₂H₄.H₂O, manufactured by Wako Pure Chemical Industries, Ltd., special grade) was dropwise added slowly to prepare a reaction liquid having a pH value (25° C.) of 4.2.

Subsequently, 20 ml of this reaction liquid was put in the hydrothermal reaction vessel 2 of the flow type reaction apparatus illustrated in FIG. 1, was heated at 100° C. for eight hours, and then was subjected to a hydrothermal reaction treatment at 270° C. for 24 hours.

A hydrothermal reaction product (liquid temperature=270° C.) was fed to the tank 9 at a rate of 0.5 ml/sec through the micro flow path 3 within one minute after a reaction occurred for a predetermined time. Note that in FIG. 1, in the cooling pipe 8, cooling water was fed such that the cooling pipe 8 maintained a temperature of 5° C. Herein, when the temperature of the dispersion liquid in the tank 9 was continuously measured, the time (liquid feeding time) until the temperature of the dispersion liquid in the tank 9 reached room temperature (25° C.) was about 12.2 seconds. Therefore, a cooling rate was 20° C./s. In addition, the pH of the dispersion liquid in the tank 9 was measured and found to be about 7.7.

The resulting dispersion liquid was filtered to separate a product, and then the product was washed with water and ethanol. Furthermore, this product was dried at 60° C. for 10 hours using a constant temperature drier to obtain vanadium dioxide-containing particles 3.

### Example 4

The hydrothermal reaction treatment was performed in a similar manner to Example 3.

Within one minute after a reaction occurred for a predetermined time, 20 ml of the hydrothermal reaction product (liquid temperature=270° C.) was fed to the tank 9 at a rate of 0.5 ml/sec through the micro flow path 3. At the same time, deionized water at room temperature (25° C.) was fed from the cooling medium tank 5 through the piping 6 at a rate of 5 ml/sec so as to be mixed with the hydrothermal reaction product. Herein, when the temperature of a dispersion liquid in the tank 9 was continuously measured, time (liquid feeding time) until the temperature of the dispersion liquid in the tank 9 reached room temperature (25° C.) was 4.9 seconds. Therefore, a cooling rate was 50° C./s. In addition, the pH of the dispersion liquid in the tank 9 was measured and was found to be about 7.6.

The resulting dispersion liquid was filtered to separate a product, and then the product was washed with water and ethanol. Furthermore, this product was dried at 60° C. for 10 hours using a constant temperature drier to obtain vanadium dioxide-containing particles 4.

### Example 5

Vanadium dioxide-containing particles 5 were obtained in a similar manner to Example 4 except that deionized water at room temperature (25° C.) was fed from the cooling medium tank 5 through the piping 6 at a rate of 50 ml/sec so as to be mixed with the hydrothermal reaction product in Example 4. Note that when the temperature of a dispersion liquid in the tank 9 was continuously measured, time (liquid feeding time) until the temperature of the dispersion liquid in the tank 9 reached room temperature (25° C.) was 2.45 seconds. Therefore, a cooling rate was 100° C./s. In addition, the pH of the dispersion liquid in the tank 9 was measured and was found to be about 7.4.

### Example 6

Vanadium dioxide-containing particles 6 were obtained in a similar manner to Example 4 except that deionized water at room temperature (25° C.) was fed from the cooling medium tank 5 through the piping 6 at a rate of 500 ml/sec so as to be mixed with the hydrothermal reaction product in Example 4. Note that when the temperature of a dispersion liquid in the tank 9 was continuously measured, time (liquid feeding time) until the temperature of the dispersion liquid in the tank 9 reached room temperature (25° C.) was about 0.82 seconds. Therefore, a cooling rate was 300° C./s. In addition, the pH of the dispersion liquid in the tank 9 was measured and was found to be about 7.2.

### Example 7

Vanadium dioxide-containing particles 7 were obtained in a similar manner to Example 5 except that nitrogen (N₂) nanobubble-treated water (liquid temperature=25° C.) was used in place of deionized water in Example 5. Incidentally, the nitrogen (N₂) nanobubble-treated water was prepared by mixing deionized water in the tank 5 with a nitrogen gas in a closed system using an ultra-high density ultra fine bubble generator (nanoQuick (registered trademark) manufactured by Nanox Co., Ltd.), and a dissolved oxygen concentration was about 0.6 mg/L. Herein, the pH of the dispersion liquid in the tank 9 was measured and was found to be about 7.5.

### Example 8

Vanadium dioxide-containing particles 8 were obtained in a similar manner to Example 5 except that deionized water at 75° C. was used in place of deionized water at room temperature (25° C.) and the temperature of the dispersion liquid in the tank 9 was maintained at 75° C. for five minutes in Example 5. Herein, the pH of the dispersion liquid in the tank 9 was measured and found to be about 7.4.

### Example 9

Vanadium dioxide-containing particles 9 were obtained in a similar manner to Example 5 except that an oxalic acid aqueous solution obtained by dissolving oxalic acid dihydrate ((COOH)₂.2H₂O, special grade, manufactured by Wako Pure Chemical Industries, Ltd.) in deionized water so as to obtain a concentration of 10 mg/L in place of deionized water in Example 5. Herein, the pH of the dispersion liquid in the tank 9 was measured and found to be about 6.0.

### Example 10

Ammonia water (concentration 28% by mass, manufactured by Wako Pure Chemical Industries, Ltd., special grade) was added to a mixed liquid of 20 ml of ethanol (manufactured by Wako Pure Chemical Industries, Ltd., first grade) and 5 ml of pure water to prepare a solution having a pH value of 11.8. To this solution, 0.3 g of tetraethyl orthosilicate ((C₂H₅O)₄Si, manufactured by Wako Pure Chemical Industries, Ltd., special grade) was added, and the mixture was stirred and mixed at 80° C. for four hours to prepare a surface modifier solution. The surface modifier solution was put in the tank 10 of FIG. 1.

Vanadium dioxide-containing particles 10 were obtained in a similar manner to Example 5 except that immediately after deionized water at room temperature (25° C.) was mixed with a hydrothermal reaction product through the piping 6 (within five seconds), the surface modifier solution (liquid temperature=25° C.) was fed from the tank 10 for surface modification through the piping 11 at a rate of 1 ml/sec so as to be mixed with the mixture of the hydrothermal reaction product and the deionized water in Example 5. Note that the pH of the dispersion liquid in the tank 9 was measured and was found to be about 7.8.

### Example 11

To 10 ml of pure water, 0.433 g of ammonium vanadate (NH₄VO₃, manufactured by Wako Pure Chemical Industries, Ltd., special grade) and 0.00957 g of ammonium para pentahydrate tungstate (NH₄)₁₀W₁₂O₄₁.5H₂O, manufactured by Wako Pure Chemical Industries, Ltd.) were mixed to obtain a mixed liquid. To this mixed liquid, a 5% by mass aqueous solution of hydrazine monohydrate (N₂H₄.H₂O, manufactured by Wako Pure Chemical Industries, Ltd., special grade) was dropwise added slowly to prepare a reaction liquid having a pH value of 9.2.

Subsequently, 20 ml of this reaction liquid was put in the hydrothermal reaction vessel 2 of the flow type reaction apparatus illustrated in FIG. 1, was heated at 100° C. for eight hours, and then was subjected to a hydrothermal reaction treatment at 270° C. for 24 hours.

Within one minute after a reaction occurred for a predetermined time, 40 ml of the hydrothermal reaction product (liquid temperature=270° C.) was fed to the tank 9 at a rate of 0.5 ml/sec through the micro flow path 3. At the same time, deionized water at room temperature (25° C.) was fed from the cooling medium tank 5 through the piping 6 at a rate of 50 ml/sec so as to be mixed with the hydrothermal reaction product. Herein, when the temperature of the hydrothermal reaction product in the tank 9 was continuously measured, time (liquid feeding time) until the temperature of the hydrothermal reaction product in the tank 9 reached room temperature (25° C.) was 2.45 seconds. Therefore, a cooling rate was 100° C./s. In addition, the pH of the dispersion liquid in the tank 9 was measured and was found to be about 7.8.

The resulting dispersion liquid was filtered to separate a product, and then the product was washed with water and ethanol. Furthermore, this product was dried at 60° C. for 10 hours using a constant temperature drier to obtain vanadium dioxide-containing particles 11. The phase transition temperature of the resulting vanadium dioxide-containing particles 11 was about 45° C. or lower.

### Example 12

A reaction liquid (pH 6.0) was prepared by adding 0.5 g of divanadium tetroxide (V₂O₄, manufactured by Shinko Chemical Industrial Co., Ltd.) to 20 ml of nitrogen (N₂) nanobubble-treated water. Incidentally, the nitrogen (N₂) nanobubble-treated water was prepared by mixing deionized water in the tank 5 with a nitrogen gas in a closed system using an ultra-high density ultra fine bubble generator (nanoQuick (registered trademark) manufactured by Nanox Co., Ltd.), and a dissolved oxygen concentration was about 0.6 mg/L.

Subsequently, 20 ml of this reaction liquid was put in the hydrothermal reaction vessel 2 of the flow type reaction apparatus illustrated in FIG. 1, was heated at 100° C. for eight hours, and then was subjected to a hydrothermal reaction treatment at 270° C. for 48 hours to obtain a hydrothermal reaction product.

Vanadium dioxide-containing particles 12 were obtained in a similar manner to Example 7 except that the hydrothermal reaction product obtained in the above was used instead in Example 7. Herein, the pH of the dispersion liquid in the tank 9 was measured and found to be about 6.5.

### Comparative Example 1

Divanadium pentoxide (V₂O₅, special grade, manufactured by Wako Pure Chemical Industries, Ltd.), oxalic acid dihydrate ((COOH)₂.2H₂O, special grade, manufactured by Wako Pure Chemical Industries, Ltd.), and 200 ml of pure water were mixed at room temperature so as to have a molar ratio of 1:2:300, and were sufficiently stirred to prepare a reaction liquid.

Subsequently, 10 ml of this reaction liquid was put in a commercially available autoclave for a hydrothermal reaction treatment (HU-25 type manufactured by San-Ai Scientific Co., Ltd.) (including a 25 ml-volume Teflon (registered trademark) inner cylinder in a main body made of stainless steel), and was subjected to a hydrothermal reaction at 270° C. for 24 hours. The reaction occurred for a predetermined time, and then the hydrothermal reaction product (liquid temperature=270° C.) was allowed to stand (cooled) until the temperature thereof reached room temperature (25° C.). Note that the cooling time was 40 minutes, and therefore a cooling rate was 0.1 (=(270−25)/(40×60)°) C/sec.

The resulting dispersion liquid was filtered to separate a product, and then the product was washed with water and ethanol. Furthermore, this product was dried at 60° C. for 10 hours using a constant temperature drier to obtain vanadium dioxide-containing particles 13.

Conditions in the above Examples 1 to 12 and Comparative Example 1 are summarized in the following Table 1.

TABLE 1

| | | Phase | | | | | | | | |
|---|---|---|---|---|---|---|---|---|---|---|
| | Vanadium- | transition | | Cooling | Cooling water | | | | | |
| | containing | control | Reducing | rate | | Mixing | | pH | | Surface |
| | compound | substance | agent | (° C./s) | Type | ratio | Temperature | regulator | pH | modifier |
| Example 1 | Divanadium | — | Oxalic | 10 | — | 0 | — | — | 4.3 | — |
| | pentoxide (V₂O₅) | | acid | | | | | | | |
| | | | dehydrate | | | | | | | |
| Example 2 | Divanadium | — | Oxalic | 20 | — | 0 | — | — | 4.3 | — |
| | pentoxide (V₂O₅) | | acid | | | | | | | |
| | | | dehydrate | | | | | | | |
| Example 3 | Divanadium | — | Hydrazine | 20 | — | 0 | — | — | 7.7 | — |
| | pentoxide (V₂O₅) | | hydrate | | | | | | | |
| Example 4 | Divanadium | — | Hydrazine | 50 | — | 10 | — | — | 7.6 | — |
| | pentoxide (V₂O₅) | | hydrate | | | | | | | |
| Example 5 | Divanadium | — | Hydrazine | 100 | Deionized water | 100 | Room | — | 7.4 | — |
| | pentoxide (V₂O₅) | | hydrate | | | | temperature | | | |
| | | | | | | | (25° C.) | | | |
| Example 6 | Divanadium | — | Hydrazine | 300 | Deionized water | 1000 | Room | — | 7.2 | — |
| | pentoxide (V₂O₅) | | hydrate | | | | temperature | | | |
| | | | | | | | (25° C.) | | | |
| Example 7 | Divanadium | — | Hydrazine | 100 | N₂ nanobubble- | 100 | Room | — | 7.5 | — |
| | pentoxide (V₂O₅) | | hydrate | | treated water | | temperature | | | |
| | | | | | | | (25° C.) | | | |
| Example 8 | Divanadium | — | Hydrazine | 100 | Deionized water | 100 | 75° C. | — | 7.4 | — |
| | pentoxide (V₂O₅) | | hydrate | | | | | | | |
| Example 9 | Divanadium | — | Hydrazine | 100 | Deionized water | 100 | Room | Oxalic | 6.0 | — |
| | pentoxide (V₂O₅) | | hydrate | | | | temperature | acid | | |
| | | | | | | | (25° C.) | dehydrate | | |
| Example 10 | Divanadium | — | Hydrazine | 100 | Deionized water | 100 | Room | — | 7.8 | Tetraethyl |
| | pentoxide (V₂O₅) | | hydrate | | | | temperature | | | orthosilicate |
| | | | | | | | (25° C.) | | | |
| Example 11 | Ammonium | Ammonium | Hydrazine | 100 | Deionized water | 100 | Room | — | 7.8 | — |
| | vanadate | para | hydrate | | | | temperature | | | |
| | (NH₄VO₃) | pentahydrate | | | | | (25° C.) | | | |
| | | tungstate | | | | | | | | |
| Example 12 | Divanadium | — | — | 100 | N₂ nanobubble- | 100 | Room | — | 6.5 | — |
| | tetroxide (V₂O₄) | | | | treated water | | temperature | | | |
| | | | | | | | (25° C.) | | | |
| Comparative | Divanadium | — | Oxalic | 0.1 | — | 0 | — | — | 4.3 | — |
| Example 1 | pentoxide (V₂O₅) | | acid | | | | | | | |
| | | | dehydrate | | | | | | | |

(Performance Evaluation)

Particle diameters (D (nm)) and polydispersity indices (PDI) of vanadium dioxide-containing particles 1 to 13 obtained in Examples 1 to 12 and Comparative Example 1 were measured according to the following methods.

In addition, hazes and thermochromic properties (ΔT (%)) of the vanadium dioxide-containing particles 1 to 13 obtained in Examples 1 to 12 and Comparative Example 1 were evaluated according to the following methods.

The results are indicated in the following Table 2.

(1) Measurement of Average Particle Diameter (D (Nm))

The prepared vanadium dioxide-containing particles were mixed with water at a concentration of 1% by mass, and were dispersed by ultrasonic wave for 15 minutes to prepare a measurement sample. A fluid mechanical diameter (nm) was measured using a dynamic light scattering analyzer (DLS-8000, manufactured by Otsuka Electronics Co., Ltd.) by a dynamic light scattering (DLS) method. An average particle diameter of a particle size distribution by cumulant analysis was determined based on the fluid mechanical diameter, and this value was taken as an average particle diameter (D (nm)).

(2) Measurement of Polydispersity Index (PDI)

The polydispersity index (PDI) is a numerical value calculated on the assumption that the particle size distribution is normally distributed in the cumulant analysis measured by the dynamic light scattering method (DLS method) in a similar manner to the above (1). If this numerical value is 0.15 or less, it can be said that a particle diameter distribution width is narrow and particle diameters are uniform. Conversely, if this numerical value is 0.30 or more, it can be said that the particle diameter distribution width is wide and particles are polydispersed.

(3) Evaluation of Thermochromic Property (ΔT (%))

The vanadium dioxide-containing particles were mixed with water at a concentration of 2% by mass, and were dispersed by ultrasonic wave for 15 minutes to prepare a dispersion liquid.

The prepared dispersion liquid was mixed with an aqueous solution of polyvinyl alcohol (trade name: Poval PVA 203 manufactured by Kuraray Co., Ltd.) so as to be 10% by mass relative to polyvinyl alcohol. The resulting mixture was applied onto a PET substrate having a thickness of 50 μm, manufactured by Teijin·DuPont Films Co., Ltd., and was dried to prepare a measurement film having a dry film thickness of 3 μm.

The measurement film was stored at 25° C./50% RH for 24 hours, and a thermochromic property thereof was evaluated. Specifically, transmittances at a wavelength of 2000 nm at 25° C./50% RH and 85° C./50% RH were measured, and a calculated difference in transmittance was defined as a thermochromic property (ΔT (%)). In addition, the above calculated difference in transmittance was evaluated according to the following evaluation criteria. Note that measurement was performed by attaching a temperature control unit (manufactured by JASCO Corporation) to a spectrophotometer V-670 (manufactured by JASCO Corporation). Note that a larger difference in transmittance is better. In the following evaluation, evaluation of “Δ” or more (difference in transmittance is 20% or more) is allowable.

[Chemical Formula 1]

[symbol]

: 50% or more
◯: 40% or more and less than 50%
◯Δ: 30% or more and less than 40%
Δ: 20% or more and less than 30%
x: less than 20%

(4) Evaluation of Haze

A haze (%) of a measurement film manufactured in a similar manner to the above (2) was measured at room temperature using a haze meter (NDH 5000 manufactured by Nippon Denshoku Industries Co., Ltd.). In addition, the haze value calculated above was evaluated according to the following criteria. Note that a smaller difference in haze (Δ (%)) is better.

[Chemical Formula 2]

[symbol]

: Difference in haze is less than 1.0%
◯: Difference in haze is 1.0% or more and less than 1.5%
Δ: Difference in haze is 1.5% or more and less than 2.5%
x: Difference in haze is 2.5% or more

TABLE 2

| | Evaluation of particles | | Evaluation of film | | | |
|---|---|---|---|---|---|---|
| | Particle | Polydispersity | | | Thermochromic | Evaluation of |
| | diameter D | index | Haze | Evaluation | property ΔT | thermochromic |
| | (nm) | (PDI) | (%) | of haze | (%) | property |
| Example 1 | 50 | 0.15 | 2.2 | Δ | 23 | Δ |
| Example 2 | 35 | 0.14 | 2.0 | Δ | 27 | Δ |
| Example 3 | 30 | 0.13 | 1.8 | Δ | 38 | ◯Δ |
| Example 4 | 22 | 0.12 | 1.5 | Δ | 45 | ◯ |
| Example 5 | 12 | 0.11 | 1.0 | ◯ | 48 | ◯ |
| Example 6 | 5 | 0.08 | 0.7 | ⊙ | 58 | ⊙ |
| Example 7 | 10 | 0.11 | 1.0 | ◯ | 52 | ⊙ |
| Example 8 | 11 | 0.10 | 1.0 | ◯ | 53 | ⊙ |
| Example 9 | 12 | 0.10 | 1.0 | ◯ | 53 | ⊙ |
| Example 10 | 8 | 0.09 | 0.8 | ⊙ | 55 | ⊙ |
| Example 11 | 14 | 0.11 | 1.2 | ◯ | 48 | ◯ |
| Example 12 | 15 | 0.11 | 1.2 | ◯ | 50 | ⊙ |
| Comparative | 50 | 0.31 | 2.8 | X | 18 | X |
| Example 1 | | | | | | |

The results in the above Table 2 indicate that the vanadium dioxide (VO₂)-containing particles in Examples have better thermochromic properties and lower hazes than those in Comparative Example. The above results are considered to be due to a fact that the vanadium dioxide (VO₂)-containing particles in Example have small and uniform particle diameters.

Furthermore, the present application is based on Japanese Patent Application No. 2015-073006 filed on Mar. 31, 2015, the disclosed contents of which are incorporated herein by reference as a whole.

### REFERENCE SIGNS LIST

1 Micro mixer
2 Hydrothermal reaction vessel
5, 9, 10 Tank
3, 6, 11 Piping
4, 7, 12 Pump
8 Cooling pipe

1. A method for manufacturing vanadium dioxide (VO₂)-containing particles having a thermochromic characteristic, comprising: performing a hydrothermal reaction of a reaction liquid containing a vanadium-containing compound and water; and cooling a reaction product immediately after the hydrothermal reaction at a cooling rate of 10 to 300° C./sec.

2. The manufacturing method according to claim 1, wherein the vanadium dioxide (VO₂)-containing particles have an average particle diameter of 35 nm or less.

3. The manufacturing method according to claim 1, wherein the hydrothermal reaction is performed in a reaction liquid containing a vanadium (V)-containing compound, water, and at least one of hydrazine (N₂H₄) and a hydrate thereof (N₂H₄.nH₂O).

4. The manufacturing method according to claim 1, wherein the hydrothermal reaction is performed in a reaction liquid containing a vanadium (IV)-containing compound and water.

5. The manufacturing method according to any one of claim 1, wherein the reaction liquid further contains a substance containing an element for controlling a phase transition temperature of the vanadium dioxide (VO₂)-containing particles.

6. The manufacturing method according to any one of claim 1, wherein the cooling is performed using a flow type reaction apparatus.

7. The manufacturing method according to any one of claim 1, wherein the cooling is performed by mixing a reaction product immediately after the hydrothermal reaction and water.

8. The manufacturing method according to claim 7, wherein at least one of water used for the hydrothermal reaction and water used for the cooling is nitrogen (N₂) nanobubble-treated water.

9. The manufacturing method according to claim 7, wherein the temperature of water used for the cooling is from 70° C. to 95° C., and the temperature of the mixture of the reaction product immediately after the hydrothermal reaction and water is maintained at 70° C. to 95° C. for five minutes or more after the reaction product immediately after the hydrothermal reaction is mixed with water.

10. The manufacturing method according to any one of claim 7, wherein the pH of the mixture of the reaction product immediately after the hydrothermal reaction and water is from 4 to 7.

11. The manufacturing method according to claim 7, wherein a surface modifier is further mixed after the reaction product immediately after the hydrothermal reaction is mixed with water.

12. Vanadium dioxide (VO₂)-containing particles manufactured by the manufacturing method according to any one of claim 1.

13. A dispersion liquid comprising the vanadium dioxide (VO₂)-containing particles according to claim 12.

14. An optical film comprising a transparent substrate and an optical functional layer formed on the transparent substrate and containing a resin and the vanadium dioxide (VO₂)-containing particles according to claim 12.

15. The manufacturing method according to claim 2, wherein the hydrothermal reaction is performed in a reaction liquid containing a vanadium (V)-containing compound, water, and at least one of hydrazine (N2H4) and a hydrate thereof (N2H4.nH2O).

16. The manufacturing method according to claim 2, wherein the hydrothermal reaction is performed in a reaction liquid containing a vanadium (IV)-containing compound and water.

17. The manufacturing method according to claim 2, wherein the reaction liquid further contains a substance containing an element for controlling a phase transition temperature of the vanadium dioxide (VO2)-containing particles.

18. The manufacturing method according to claim 2, wherein the cooling is performed using a flow type reaction apparatus.

19. The manufacturing method according to claim 2, wherein the cooling is performed by mixing a reaction product immediately after the hydrothermal reaction and water.

20. Vanadium dioxide (VO2)-containing particles manufactured by the manufacturing method according to claim 2.
